(19) United States
(12) Patent Application Publication
(10) Pub. No.: US 2025/0120531 A1
(43) Pub. Date: Apr. 17, 2025

(54) Baking Pan Device

(71) Applicant: Robert McKinney, Blue Springs, MO (US)

(72) Inventor: Robert McKinney, Blue Springs, MO (US)

(21) Appl. No.: 18/823,907

(22) Filed: Sep. 4, 2024

Related U.S. Application Data
(60) Provisional application No. 63/589,332, filed on Oct. 11, 2023.

(51) Int. Cl. A47J 27/00; A23B 4/052; A47J 36/02; A47J 36/04; A47J 36/20; A47J 36/22

(52) U.S. Cl. CPC A47J 27/002; A23B 4/052; A47J 36/025; A47J 36/04; A47J 36/20; A47J 36/22

(57) ABSTRACT

A baking pan device is disclosed for enhancing the flavor of meatloaf and other food items cooked in a rectangular baking pan. The baking pan device comprises a pan component that is configured in a standard sizes steel loaf pan with a plurality of ventilation holes evenly spaced along the sides and bottom of the pan component. The device also includes a removable and replaceable stainless steel heat resistant moisture retaining insert component with two handles on either side, that is positioned directly within the pan component. The insert component is also lined with evenly spaced ventilation holes to allow smoke to penetrate the meat whilst cooking on a grill or smoker. The insert component is for lifting the meat out of the pan component, leaving any fat or grease in the pan component, and not saturating the meat when cut and served.

### CROSS-REFERENCE TO RELATED APPLICATION

The present application claims priority to, and the benefit of, U.S. Provisional Application No. 63/589,332, which was filed on Oct. 11, 2023, and is incorporated herein by reference in its entirety.

### FIELD OF THE INVENTION

The present invention relates generally to the field of baking pan devices. More specifically, the present invention relates to a ventilated pan for cooking meatloaf and absorbing smoke while cooked in a smoker. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in baking pan devices. Generally, people who enjoy meatloaf may cook the food in a standard reusable or disposable baking pan. The pan fully surrounds the meat and does not allow any smoke to be infused into the meat, if cooked in a smoker. People may opt to use artificial flavorings like liquid smoke to obtain the ‘smoky’ taste they desire in their meatloaf; however, these may not be optimal for obtaining true flavor.

Furthermore, there are several problems associated with the baking of meatloaf in conventional loaf pans. First, the loaves of meat have a tendency to stick to the sides of the pan, making removal of the intact meatloaf difficult if not impossible. Removal often necessitates skewering the tender meat with a fork or knife and then lifting it from the pan, thereby damaging its aesthetic appearance. Second, transferring the meatloaf from a pan to a plate often results in breakage of the meatloaf. The third problem relates to the accumulation of grease in the bottom of the pan that has drained from the meatloaf during baking. This grease causes a mess when the meatloaf is removed from the pan.

Accordingly, there is a demand for an improved baking pan device that has ventilation holes along the sides and base of the pan to infuse smoke and drain the meatloaf. More particularly, there is a demand for a baking pan device that includes an insert with two handles to allow users to easily lift out the meatloaf once cooked.

Therefore, there exists a long felt need in the art for a baking pan device that provides users with a ventilated pan for cooking meatloaf and absorbing smoke while cooked in a smoker. There is also a long felt need in the art for a baking pan device that features ventilation holes spaced evenly along the sides and base of the pan to infuse the dish with smoke. Further, there is a long felt need in the art for a baking pan device that includes an insert with two handles on either side that can be placed within the pan, allowing users to easily lift out the meat once cooked. Moreover, there is a long felt need in the art for a device that improves and enhances flavor with natural smoke rather than needing any artificial ingredients. Further, there is a long felt need in the art for a baking pan device that provides an insert for lifting the meatloaf out of the pan and leaving any fat or grease in the pan. Finally, there is a long felt need in the art for a baking pan device that is manufactured out of stainless steel.

The subject matter disclosed and claimed herein, in one embodiment thereof, comprises a baking pan device. The device is a pan for enhancing the flavor of meatloaf and other food items cooked in a rectangular baking pan. The baking pan device comprises a pan component that is configured in a standard sizes steel loaf pan with a plurality of ventilation holes evenly spaced along the sides and bottom of the pan component. Thus, the ventilated pan is ideal for cooking meatloaf and absorbing smoke to infuse the meat with a smoky flavor. The device also includes a removable and replaceable stainless steel heat resistant moisture retaining insert component with two handles on either side that surpass the perimeter of the pan component and is positioned directly within the pan component. The insert component is also lined with evenly spaced ventilation holes to allow smoke to penetrate the meat whilst cooking on a grill or smoker. The insert component is for lifting the meat out of the pan component, leaving any fat or grease in the pan component, and not saturating the meat when cut and served. Thus, users can infuse their meatloaf with a natural flavor while cooking it in a smoker or other device.

In this manner, the baking pan device of the present invention accomplishes all of the forgoing objectives and provides users with a device that allows for the absorption of smoke while meatloaf is cooked in a smoker. The device is a baking pan with a plurality of ventilation holes. The device can be manufactured of stainless steel.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a baking pan device. The device is a pan for enhancing the flavor of meatloaf and other food items cooked in a rectangular baking pan. The baking pan device comprises a pan component with a plurality of ventilation holes along the sides and bottom of the pan component. The device also includes an insert component with two handles on either side, which is positioned directly within the pan component. The insert component is also lined with evenly spaced ventilation holes to allow smoke to penetrate the meat whilst cooking on a grill or smoker.

In one embodiment, the baking pan device provides users with a ventilated pan for cooking meatloaf and absorbing smoke while cooked in a smoker. Thus, users can infuse their meatloaf with a natural flavor while cooking it in a smoker or other device. Accordingly, the ventilated pan is ideal for cooking meatloaf and other food items and absorbing smoke to infuse the meat with a smoky flavor.

In one embodiment, the baking pan device comprises a pan component that is configured in a standard sized steel loaf pan. The pan component comprises a longitudinally elongated, upstanding meatloaf pan of generally rectangular configuration, designed to hold a meatloaf of traditional loaf configuration. The pan component has an open top and a closed bottom, and impervious side walls, attached to the bottom along their common edges to form a receptacle for receiving a meatloaf, bread, or other product that requires baking. Further, the pan component is made of a strong, lightweight material, such as metal or ceramic. The pan component includes pan flanges which protrude from the top edge of the side walls, extending outward, horizontally, serving as gripping means for the pan component.

In one embodiment, the pan component comprises a plurality of ventilation holes, any suitable number of ventilation holes can be utilized with the pan component as is known in the art. The plurality of ventilation holes are through-holes and are evenly spaced along the side walls and bottom of the pan component. The ventilation holes can be any suitable size and shape as is known in the art. The ventilation holes allow smoke to enter and be absorbed by the meatloaf or other food item within the pan component. The ventilation holes also allow grease or fat to be pulled away from the meatloaf or other food item within the pan component and drained out.

In one embodiment, the baking pan device comprises a removable and replaceable stainless steel heat resistant moisture retaining insert component. The insert component has a longitudinally elongated, relatively flat, insert bottom of generally rectangular configuration, dimensioned to fit within the pan component. The insert component is designed to hold a meatloaf or other meat or bread, and to be inserted within the pan component. Once the food is cooked, the insert component, as well as the food, may be removed from the pan component. Further, the insert component is made from a strong, lightweight material, such as metal or ceramic.

The insert component has two longitudinally elongated, insert side panels, of generally rectangular configuration, designed to retain the food and also serve as carrying handles for a user to grasp when removing the insert component from the pan component. Each insert side panel extends upward from the insert bottom and extends past (i.e., surpasses) the perimeter of the pan component, when the insert component is positioned within the pan component. Thus, the vertical height of each insert component/carrying handle is sufficient to allow an individual to insert their fingers between the carrying handle and the pan component perimeter when the insert component is in position inside the pan component. Each insert side panel is connected along an edge of the insert bottom via welds, rivets, or pins, etc. In another embodiment, the opposing side panels are an integral part of the insert bottom and formed as one piece.

In one embodiment, the vertical height of the insert side panels is such that when the insert component is placed inside the pan component, the insert bottom does not come into contact with the bottom of the pan component.

In another embodiment, the side panels are secured to the insert bottom via hinges. The hinges are designed to allow each insert side panel to pivot in the vertical plane along the corresponding edge of the insert bottom, such that the insert side panels can rest in the vertical plane during baking inside of the pan component, supporting the meatloaf, and can rest horizontally after removal of the insert component from the pan component, thus allowing the insert component to serve as a cutting and serving tray.

In one embodiment, the insert component comprises a plurality of ventilation holes, much like the pan component. The plurality of ventilation holes are evenly spaced holes positioned along the insert bottom and the insert side panels. When the insert component is spaced above the pan component bottom, the ventilation holes are designed to facilitate the runoff of grease from the insert bottom into the bottom of the pan component during baking. Any suitable number of ventilation holes can be utilized with the insert component as is known in the art. The plurality of ventilation holes are through-holes and can be any suitable size and shape as is known in the art. The ventilation holes allow smoke to enter and be absorbed by the meatloaf or other food item within the insert component. The ventilation holes also allow grease or fat to be pulled away from the meatloaf or other food item within the insert component and drained out into the pan component or other surface.

In one embodiment, a non-stick material, such as Teflon, is placed on all surfaces of the insert component and the pan component.

In one embodiment, a heat resistant mesh insert is placed in the bottom of the pan component. The mesh insert allows smoke in towards the meatloaf but prevents grease and fat from dripping out of the pan component into the smoker or grill.

In operation, the user places a meatloaf or bread into the insert component then places the insert component into the pan component. The user then places both into the smoker or grill. Once the meat or bread is cooked, the user removes the device from the smoker and then removes the insert component from the pan component. The user then places the insert component on a table. The user can then cut and serve the meatloaf.

In yet another embodiment, the baking pan device comprises a plurality of indicia.

In yet another embodiment, a method of infusing smoke flavor into a meatloaf is disclosed. The method includes the steps of providing a baking pan device comprising a pan component and insert component with ventilation holes for cooking meatloaf. The method also comprises inserting the insert component into the pan component. Further, the method comprises inserting meatloaf into the pan component. The method also comprises cooking the meatloaf in a smoker while absorbing smoke flavor through the ventilation holes. Finally, the method comprises removing the insert component with the meatloaf, to cat the meatloaf.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one embodiment of the baking pan device of the present invention in accordance with the disclosed architecture;

FIGS. 2A-B illustrate a perspective view of one embodiment of the baking pan device of the present invention showing the insert component in accordance with the disclosed architecture;

FIG. 3 illustrates a perspective view of one embodiment of the baking pan device of the present invention showing the plurality of ventilation holes on the pan component in accordance with the disclosed architecture;

FIG. 4 illustrates a top perspective view of one embodiment of the baking pan device of the present invention showing the rectangular configuration of the pan component in accordance with the disclosed architecture; and

FIG. 5 illustrates a flowchart showing the method of infusing smoke flavor into a meatloaf in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a baking pan device that provides users with a ventilated pan for cooking meatloaf and absorbing smoke while cooked in a smoker. There is also a long felt need in the art for a baking pan device that features ventilation holes spaced evenly along the sides and base of the pan to infuse the dish with smoke. Further, there is a long felt need in the art for a baking pan device that includes an insert with two handles on either side that can be placed within the pan, allowing users to easily lift out the meat once cooked. Moreover, there is a long felt need in the art for a device that improves and enhances flavor with natural smoke rather than needing any artificial ingredients. Further, there is a long felt need in the art for a baking pan device that provides an insert for lifting the meatloaf out of the pan and leaving any fat or grease in the pan. Finally, there is a long felt need in the art for a baking pan device that is manufactured out of stainless steel.

The present invention, in one exemplary embodiment, is a novel baking pan device. The baking pan device comprises a pan component that is configured in a standard sizes steel loaf pan with a plurality of ventilation holes evenly spaced along the sides and bottom of the pan component. The device also includes a removable and replaceable stainless steel heat resistant moisture retaining insert component with two handles on either side that surpass the perimeter of the pan component and is positioned directly within the pan component. The insert component is also lined with evenly spaced ventilation holes to allow smoke to penetrate the meat whilst cooking on a grill or smoker. The insert component is for lifting the meat out of the pan component, leaving any fat or grease in the pan component, and not saturating the meat when cut and served. The present invention also includes a novel method of infusing smoke flavor into a meatloaf. The method includes the steps of providing a baking pan device comprising a pan component and insert component with ventilation holes for cooking meatloaf. The method also comprises inserting the insert component into the pan component. Further, the method comprises inserting meatloaf into the pan component. The method also comprises cooking the meatloaf in a smoker while absorbing smoke flavor through the ventilation holes. Finally, the method comprises removing the insert component with the meatloaf, to eat the meatloaf.

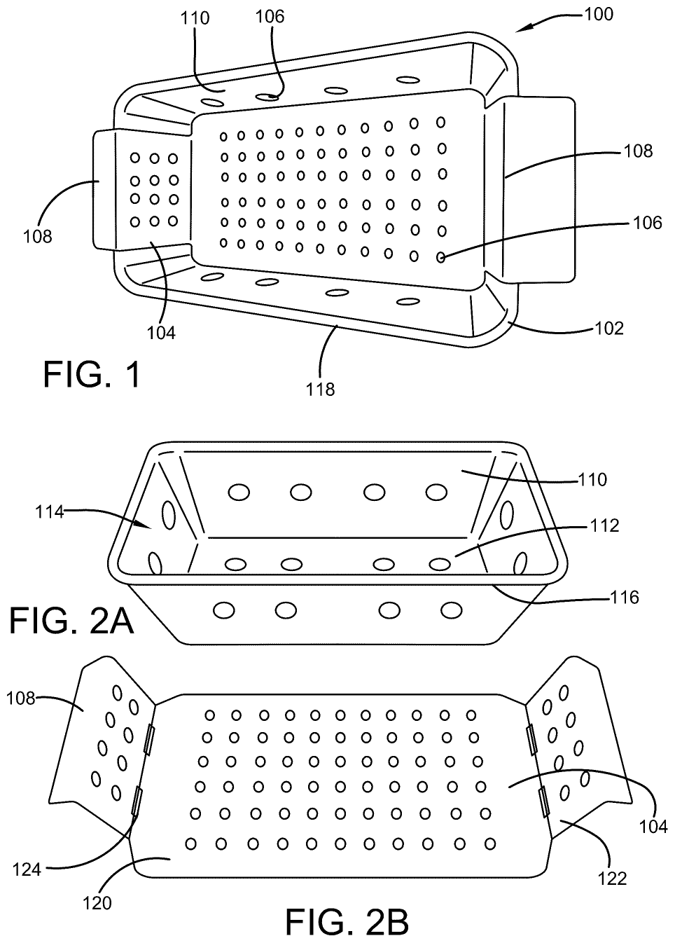

Referring initially to the drawings, FIG. 1 illustrates a perspective view of one embodiment of the baking pan device 100 of the present invention. In the present embodiment, the baking pan device 100 is an improved baking pan device 100 that provides a user with a pan for enhancing the flavor of meatloaf and other food items. Specifically, the baking pan device 100 comprises a pan component 102 with a plurality of ventilation holes 106 along the side walls 110 and bottom 112 of the pan component 102. The device 100 also includes an insert component 104 with two handles 108 on either side, which is positioned directly within the pan component 102. The insert component 104 also comprises ventilation holes 106 to allow smoke to penetrate the meat whilst cooking on a grill or smoker.

Generally, the baking pan device 100 provides users with a ventilated pan for cooking meatloaf and absorbing smoke while cooked in a smoker. Thus, users can infuse their meatloaf with a natural flavor while cooking it in a smoker or other device. Accordingly, the ventilated pan is ideal for cooking meatloaf and other food items and absorbing smoke to infuse the meat with a smoky flavor.

Further, the baking pan device 100 comprises a pan component 102 that is configured in a standard sized steel loaf pan. The pan component 102 comprises a longitudinally elongated, upstanding meatloaf pan of generally rectangular configuration, designed to hold a meatloaf of traditional loaf configuration. The pan component 102 has an open top 114 and a closed bottom 112, and impervious side walls 110, attached to the bottom 112 along their common edges to form a receptacle for receiving a meatloaf, bread, or other product that requires baking. Further, the pan component 102 is made of a strong, lightweight material, such as metal or ceramic. The pan component 102 includes pan flanges 116 which protrude from the top edge 118 of the side walls 110, extending outward, horizontally, serving as gripping means for the pan component 102.

Additionally, the pan component 102 comprises a plurality of ventilation holes 106, any suitable number of ventilation holes 106 can be utilized with the pan component 102 as is known in the art. The plurality of ventilation holes 106 are through-holes and are evenly spaced along the side walls 110 and bottom 112 of the pan component 102. The ventilation holes 106 can be any suitable size and shape as is known in the art. The ventilation holes 106 allow smoke to enter and be absorbed by the meatloaf or other food item within the pan component 102. The ventilation holes 106 also allow grease or fat to be pulled away from the meatloaf or other food item within the pan component 102 and drained out.

As shown in FIGS. 2A-B, the baking pan device 100 comprises a removable and replaceable stainless steel heat resistant moisture retaining insert component 104. The insert component 104 has a longitudinally elongated, relatively flat, insert bottom 120 of generally rectangular configuration, dimensioned to fit within the pan component 102. The insert component 104 is designed to hold a meatloaf or other meat or bread, and to be inserted within the pan component 102. Once the food is cooked, the insert component 104, as well as the food, may be removed from the pan component 102. Further, the insert component 104 is made from a strong, lightweight material, such as metal or ceramic.

The insert component 104 has two longitudinally elongated, insert side panels 122 of generally rectangular configuration, designed to retain the food and also serve as carrying handles 108 for a user to grasp when removing the insert component 104 from the pan component 102. Each insert side panel 122 extends upward from the insert bottom 120 and extends past (i.e., surpasses) the perimeter of the pan component 102, when the insert component 104 is positioned within the pan component 102. Thus, the vertical height of each insert side panel 122/carrying handle 108 is sufficient to allow an individual to insert their fingers between the carrying handle 108 and the pan component 102 perimeter when the insert component 104 is in position inside the pan component 102. Each insert side panel 122 is connected along an edge of the insert bottom 120 via welds, rivets, or pins, etc. In another embodiment, the opposing side panels 122 are an integral part of the insert bottom 120 and formed as one piece.

In one embodiment, the vertical height of the insert side panels 122 is such that when the insert component 104 is placed inside the pan component 102, the insert bottom 120 does not come into contact with the bottom 112 of the pan component 102. In another embodiment, the insert bottom 120 is in direct contact with the bottom 112 of the pan component 102.

In another embodiment, the side panels 122 are secured to the insert bottom 120 via hinges 124. The hinges 124 are designed to allow each insert side panel 122 to pivot in the vertical plane along the corresponding edge of the insert bottom 120, such that the insert side panels 122 can rest in the vertical plane during baking inside of the pan component 102, supporting the meatloaf, and can rest horizontally after removal of the insert component 104 from the pan component 102, thus allowing the insert component 104 to serve as a cutting and serving tray.

Furthermore, the insert component 104 comprises a plurality of ventilation holes 106, much like the pan component 102. The plurality of ventilation holes 106 are evenly spaced holes positioned along the insert bottom 120 and the insert side panels 122. When the insert component 104 is spaced above the pan component bottom 112, the ventilation holes 106 are designed to facilitate the runoff of grease from the insert bottom 120 into the bottom 112 of the pan component 102 during baking. Any suitable number of ventilation holes 106 can be utilized with the insert component 104 as is known in the art. The plurality of ventilation holes 106 are through-holes and can be any suitable size and shape as is known in the art. The ventilation holes 106 allow smoke to enter and be absorbed by the meatloaf or other food item within the insert component 104. The ventilation holes 106 also allow grease or fat to be pulled away from the meatloaf or other food item within the insert component 104 and drained out into the pan component 102 or another surface.

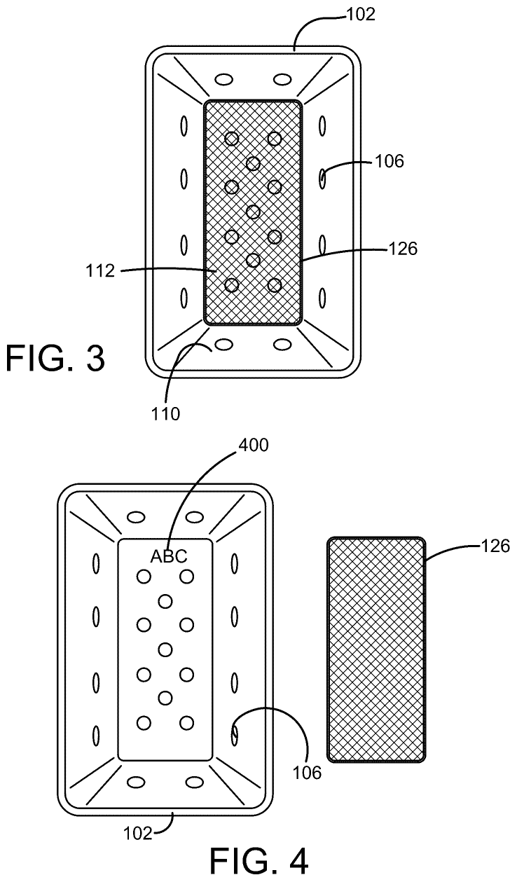

As shown in FIGS. 3-4, a non-stick material, such as Teflon, is placed on all surfaces of the insert component 104 and the pan component 102.

In one embodiment, a heat resistant mesh insert 126 is placed in the bottom 112 of the pan component 102. The mesh insert 126 allows smoke in towards the meatloaf but prevents grease and fat from dripping out of the pan component 102 into the smoker or grill.

In yet another embodiment, the baking pan device 100 comprises a plurality of indicia 400. The pan component 102 of the device 100 may include advertising, a trademark, or other letters, designs, or characters, printed, painted, stamped, or integrated into the pan component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be meatloaf, baking pan, or brand related.

In operation, the user places a meatloaf or bread into the insert component 104 then places the insert component 104 into the pan component 102. The user then places both into the smoker or grill. Once the meat or bread is cooked, the user removes the device 100 from the smoker and then removes the insert component 104 from the pan component 102. The user then places the insert component 104 on a table. The user can then cut and serve the meatloaf.

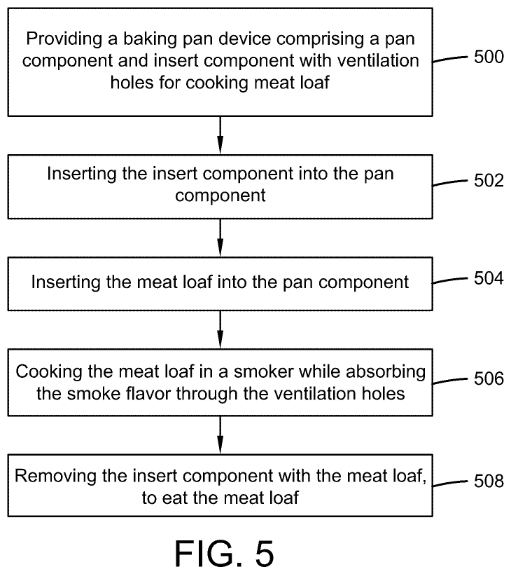

FIG. 5 illustrates a flowchart of the method of infusing smoke flavor into a meatloaf. The method includes the steps of at 500, providing a baking pan device comprising a pan component and insert component with ventilation holes for cooking meatloaf. The method also comprises at 502, inserting the insert component into the pan component. Further, the method comprises at 504, inserting meatloaf into the pan component. The method also comprises at 506, cooking the meatloaf in a smoker while absorbing smoke flavor through the ventilation holes. Finally, the method comprises at 508, removing the insert component with the meatloaf, to cat the meatloaf.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “baking pan device”, “baking device”, “pan device”, and “device” are interchangeable and refer to the baking pan device 100 of the present invention.

Notwithstanding the forgoing, the baking pan device 100 of the present invention can be of any suitable size and configuration as is known in the art without affecting the overall concept of the invention, provided that it accomplishes the above stated objectives. One of ordinary skill in the art will appreciate that the baking pan device 100 as shown in FIGS. 1-5 is for illustrative purposes only, and that many other sizes and shapes of the baking pan device 100 are well within the scope of the present disclosure. Although the dimensions of the baking pan device 100 are important design parameters for user convenience, the baking pan device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A baking pan device that provides a user with a pan for enhancing the flavor of a meatloaf, the baking pan device comprising:
a pan component comprising a plurality of ventilation holes, wherein the plurality of ventilation holes allow smoke to penetrate the meatloaf whilst cooking on a smoker.

2. The baking pan device of claim 1, wherein the pan component is configured in a standard sized steel loaf pan.

3. The baking pan device of claim 2, wherein the pan component comprises a longitudinally elongated, upstanding meatloaf pan of generally rectangular configuration, designed to hold a meatloaf of traditional loaf configuration.

4. The baking pan device of claim 3, wherein the pan component has an open top and a closed bottom, and side walls, attached to the bottom along their common edges to form a receptacle for receiving a meatloaf, bread, or other product that requires baking.

5. The baking pan device of claim 4, wherein the pan component is made of a strong, lightweight material, such as metal or ceramic.

6. The baking pan device of claim 5, wherein the pan component includes pan flanges which protrude from a top edge of the side walls, extending outward, horizontally, serving as gripping means for the pan component.

7. The baking pan device of claim 6, wherein the plurality of ventilation holes are through-holes and are evenly spaced along the side walls and the closed bottom of the pan component.

8. The baking pan device of claim 7, wherein the baking pan device comprises an insert component.

9. The baking pan device of claim 8, wherein the insert component has an insert bottom of generally rectangular configuration, dimensioned to fit within the pan component.

10. The baking pan device of claim 9, wherein the insert component is designed to hold a meatloaf and to be inserted within the pan component.

11. The baking pan device of claim 10, wherein the insert component has two insert side panels which extend upwards from the insert bottom and extends past a perimeter of the pan component.

12. The baking pan device of claim 11, wherein the two insert side panels extend into a carrying handle.

13. The baking pan device of claim 12, wherein the insert component comprises a plurality of ventilation holes, which are evenly spaced along the insert bottom and the insert side panels.

14. A baking pan device that provides a user with a pan for enhancing the flavor of a meatloaf, the baking pan device comprising:
a pan component in a rectangular configuration having an open top and a closed bottom, and side walls, attached to the closed bottom along their common edges; and
an insert component comprising an insert bottom of generally rectangular configuration, dimensioned to fit within the pan component; and
wherein the pan component comprises a plurality of ventilation holes;
wherein the pan component includes pan flanges which protrude from a top edge of the side walls, extending outward, horizontally, serving as gripping means for the pan component; wherein the plurality of ventilation holes are through-holes and are evenly spaced along the side walls and the closed bottom of the pan component;
wherein the insert component has two insert side panels which extend upwards from the insert bottom and extends past a perimeter of the pan component;
wherein the two insert side panels extend into a carrying handle;
wherein the insert component comprises a plurality of ventilation holes, which are evenly spaced along the insert bottom and the insert side panels; and
further wherein the plurality of ventilation holes allow smoke to penetrate the meat loaf whilst cooking on a smoker.

15. The baking pan device of claim 14, wherein vertical height of the insert side panels is such that when the insert component is placed inside the pan component, the insert bottom does not come into contact with the bottom of the pan component.

16. The baking pan device of claim 14, wherein the insert side panels are secured to the insert bottom via hinges that allow the insert side panels to pivot up and down.

17. The baking pan device of claim 14, wherein a non-stick material, such as Teflon, is placed on all surfaces of the insert component and the pan component.

18. The baking pan device of claim 14, wherein a heat resistant mesh insert is placed in the closed bottom of the pan component.

19. The baking pan device of claim 14 further comprising a plurality of indicia.

20. A method of infusing smoke flavor into a meatloaf, the meatloaf comprising the following steps:
providing a baking pan device comprising a pan component and insert component with ventilation holes for cooking meatloaf;
inserting the insert component into the pan component;
inserting meatloaf into the pan component;
cooking the meatloaf in a smoker while absorbing smoke flavor through the ventilation holes; and
removing the insert component with the meatloaf, to eat the meatloaf.
